(19) United States
(12) Patent Application Publication
(10) Pub. No.: US 2015/0081417 A1
(43) Pub. Date: Mar. 19, 2015

(54) SYSTEM AND METHOD FOR COLLABORATIVE MARKETING WITH ONLINE BRAND ENGAGEMENT ADVERTISING

(71) Applicant: Apparel Media Group, Inc., Chicago, IL (US)

(72) Inventors: Jared Golden, Chicago, IL (US); Amish Tolia, Chicago, IL (US); Chris Molnar, Chicago, IL (US); Gerry Hays, Carmel, IN (US)

(73) Assignee: Apparel Media Group, Inc., Chicago, IL (US)

(21) Appl. No.: 14/031,713

(22) Filed: Sep. 19, 2013

(51) Int. Cl. G06Q 30/02

(52) U.S. Cl. CPC G06Q 30/0242; G06Q 30/0269
USPC 705/14.41

(57) ABSTRACT

A system and method for collaborative marketing with online brand engagement advertising is provided and includes receiving specification data for brand engagement advertising campaigns from a sponsor. The specification data includes data indicating a brand engagement advertising activity and a group incentive. A server stores the specification data and provides access to the specification data to users. The server receives a selection of a designated brand engagement advertising campaign and monitors performance of the brand engagement advertising activities. The server generates a notification of a group incentive for a group of users based on the monitored performance of the designated brand engagement advertising activities associated with the designated brand engagement advertising campaign.

### FIELD

The present disclosure relates to systems and methods for collaborative marketing with online brand engagement advertising and, in particular, to systems and methods for coordinating sponsor submitted brand engagement advertising campaigns with users associated with particular groups or events, monitoring and tracking performance of associated brand engagement advertising activities, and distributing designated incentives to users and groups.

### BACKGROUND

This section provides background information related to the present disclosure which is not necessarily prior art.

Companies that are in the business of selling goods and services to consumers are generally seeking ways to increase awareness of and interaction with their brand via online campaigns designed to engage consumers in target segments. For example, brand engagement advertising activities may include interacting with a particular company or brand via a social media outlet, such as Facebook®, Twitter®, Pinterest®, or Google+®, watching a video or advertisement associated with the particular company or brand, visiting a website associated with the particular company or brand, participating in a survey with questions regarding the particular company or brand, opting-in to an email list for information associated with the particular company or brand, creating an account or purchasing from the company or brand via its online sales outlet/website, and other similar related activities. Companies, for example, may provide online brand engagement advertising opportunities through websites and social media outlets, but traditionally have not had a coordinated way to drive increased online brand engagement advertising activities by consumers.

At the same time, local groups, such as sports teams, charity organizations, school groups, community groups, and the like, are generally seeking sponsorship backing by local and national businesses and brands. For example, local groups may seek to obtain sponsorship backing by a company to raise money for their own group/cause, or for a third party, such as a not-for-profit to which they have pledged support. For example, a group may seek to obtain sponsorship backing so that the group can purchase customized uniforms or t-shirts. In exchange for providing sponsorship backing for the group, the company name or logo may be printed on the uniforms or t-shirts, which serves as a form of advertising for the company. Local groups, however, have not had a coordinated way to seek and obtain such sponsorship backing from local or national businesses or brands.

### SUMMARY

This section provides a general summary of the disclosure, and is not a comprehensive disclosure of its full scope or all of its features.

In various embodiments of the present disclosure, a method is disclosed that includes receiving, at a server, specification data for a plurality of brand engagement advertising campaigns from at least one sponsor. The specification data for each brand engagement advertising campaign includes data indicating at least one brand engagement advertising activity and a group incentive for the associated brand engagement advertising campaign. The method also includes storing, at the server, the specification data for the plurality of brand engagement advertising campaigns and providing, at the server, access to the specification data for the plurality of brand engagement advertising campaigns to a plurality of users. The method also includes receiving, at the server and from a first user of the plurality of users, a selection of a designated brand engagement advertising campaign from the plurality of brand engagement advertising campaigns, the designated brand engagement advertising campaign having an associated sponsor. The method also includes monitoring, with the server, performance of the at least one brand engagement advertising activity associated with the designated brand engagement advertising campaign by the first user and at least one second user from the plurality of users. The method also includes notifying, with the server, the first user that the group incentive associated with the designated brand engagement advertising campaign has been awarded by the associated sponsor for the designated brand engagement advertising campaign, based on the monitored performance of the at least one designated brand engagement advertising activity associated with the designated brand engagement advertising campaign.

In various embodiments of the present disclosure, a server is disclosed. The server includes a computer readable storage medium storing instructions executable by a processor for receiving specification data for a plurality of brand engagement advertising campaigns from at least one sponsor. The specification data for each brand engagement advertising campaign includes data indicating at least one brand engagement advertising activity and a group incentive for the associated brand engagement advertising campaign. The computer readable storage medium also stores instructions executable by the processor for storing the specification data for the plurality of brand engagement advertising campaigns and providing access to the specification data for the plurality of brand engagement advertising campaigns to a plurality of users. The computer readable storage medium also stores instructions executable by the processor for receiving, from a first user, of the plurality of users a selection of a designated brand engagement advertising campaign from the plurality of brand engagement advertising campaigns, the designated brand engagement advertising campaign having an associated sponsor. The computer readable storage medium also stores instructions executable by the processor for monitoring performance of the at least one brand engagement advertising activity associated with the designated brand engagement advertising campaign by the first user and at least one second user from the plurality of users. The computer readable storage medium also stores instructions executable by the processor for notifying the first user that the group incentive associated with the designated brand engagement advertising campaign has been awarded by the associated sponsor for the designated brand engagement advertising campaign, based on the monitored performance of the at least one designated brand engagement advertising activity associated with the designated brand engagement advertising campaign.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example collaborative marketing system according to some embodiments of the present disclosure.

FIG. 1 illustrates another example collaborative marketing system according to some embodiments of the present disclosure.

FIG. 3 is a flow chart illustrating a technique of the present disclosure.

FIG. 4 is a flow chart illustrating a technique of the present disclosure.

FIG. 5 is a flow chart illustrating a technique of the present disclosure.

FIG. 6 is a flow chart illustrating a technique of the present disclosure.

FIG. 7 is an example screen shot of generated content in accordance with the present disclosure.

FIG. 8 is an example screen shot of generated content in accordance with the present disclosure.

FIG. 9 is an example screen shot of generated content in accordance with the present disclosure.

FIG. 10 is an example screen shot of generated content in accordance with the present disclosure.

FIG. 11 is an example screen shot of generated content in accordance with the present disclosure.

FIG. 12 is an example screen shot of generated content in accordance with the present disclosure.

FIG. 13 is illustrates another example collaborative marketing system according to some embodiments of the present disclosure.

FIGS. 14 and 15 illustrate particular database tables and fields used by a collaborative marketing system according to some embodiments of the present disclosure.

FIG. 16 is a flow chart illustrating a technique of the present disclosure.

Corresponding reference numerals indicate corresponding parts throughout the several views of the drawings.

### DETAILED DESCRIPTION

Example embodiments will now be described more fully with reference to the accompanying drawings.

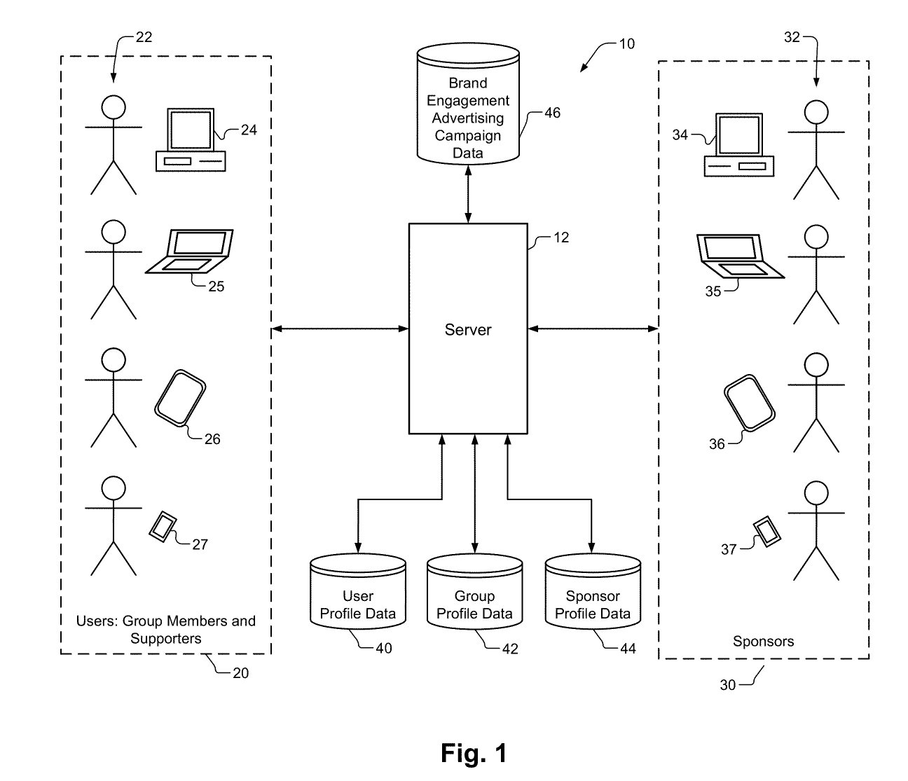

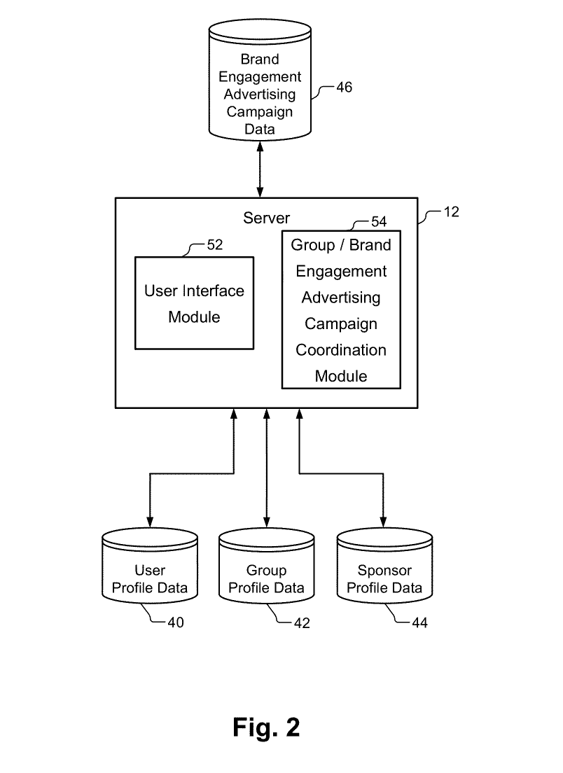

With reference to FIG. 1, a collaborative marketing system 10 is shown and includes, for example, a server 12 in communication with multiple users 20 and with multiple sponsors 30. Specifically, the individual users 22 may access the server using various computing devices, including, for example, a desktop computer 24, a laptop computer 25, a tablet device 26, a mobile device 27, such as a smartphone, or any other suitable computer device. The users 20 may include, for example, individuals involved in a particular sports team, charity organization, school group, community group, etc. Likewise, the individual sponsors 32 may likewise access the server using the same types of computing devices, including, for example, a desktop computer 34, a laptop computer 35, a tablet device 36, a mobile device 37, such as a smartphone, or any other suitable computer device. While the individual sponsors 32 are shown in FIG. 1 as individual people, it is understood that the individual sponsors 32 can be businesses, companies, or advertisers and that the individual sponsors 32 can, in practice, interact with the collaborative marketing system 10 through a designated representative or employee, as appropriate. The sponsors 32 may include, for example, businesses, companies, or advertisers that utilize the collaborative marketing system 10 to drive, track, and measure online brand engagement advertising activities with consumers.

The server 12 can access a number of databases that store information related to the collaborative marketing system 10. For example, the server 12 can receive user profile data for the individual users 22 which is then stored by the server 12 in a user profile database 40 and accessed by the server 12 as needed. Additionally, the server 12 can receive group profile data for a group of individual users 22, such as a sports team, a charity organization, a school group, a community group, and the like, which is then stored by the server 12 in a group profile database 42 and accessed by the server as needed. Additionally, the server 12 can receive sponsor profile data for the individual sponsors 32 which is then stored by the server in a sponsor profile database 44 and accessed by the server 12 as needed.

The server 12 can receive specification data for proposed brand engagement advertising campaigns from the sponsors 30. The specification data for the proposed brand engagement advertising campaigns is then stored in a brand engagement advertising campaign database 46 and accessed by the server 12 as needed. A brand engagement advertising campaign may generally include a sponsorship offer by an individual sponsor 32 to provide a group incentive, such as funds towards custom apparel including t-shirts or uniforms, to a group of users, such as a sports team or charity organization, etc., upon the successful completion of designated brand engagement advertising activities.

As discussed in further detail below, the incentives associated with a brand engagement advertising campaign can take many different forms and may include, for example, funds towards sponsor branded custom apparel, such as uniforms, t-shirts, jackets, etc., funds towards products and/or services, funds to be submitted as a donation for a charity or nonprofit organization, funds for a fundraiser, funds towards food or catering, or any other suitable or appropriate incentives or awards.

Further, as discussed in detail below, the specific brand engagement advertising activities can likewise take many different forms and can include, for example, joining the brand engagement advertising campaign as a supporter. The brand engagement advertising activities can also include interacting with the sponsor via a social media outlet, such as Facebook®, Twitter®, Pinterest®, Google+®, LinkedIn®, and the like. For example, the brand engagement advertising activity can include “Liking” the sponsor on Facebook® or re-tweeting a sponsor's tweet on Twitter®. The brand engagement advertising activities can also include watching a video, such as a commercial, associated with the sponsor, visiting the sponsor's website, participating in a survey associated with the sponsor or the sponsor's products or brands, opting-in to an email distribution list, creating an account with the sponsor, making a purchase from the sponsor or a retailer, company or brand designated by the sponsor via an online sales outlet or website. The brand engagement advertising activities can also include any other suitable or appropriate online interaction with a sponsor or brand that can, for example, be monitored and tracked.

Once a particular group of users initiates participation in a brand engagement advertising campaign, the users can rally supporters, such as their friends and family, to participate in the brand engagement advertising campaign by performing the designated brand engagement advertising activities associated with the campaign. The server 12 can then monitor and track the brand engagement advertising activities performed by the group of users and their supporters by keeping a cumulative tally of “points” earned by the group of users and their supporters. Different brand engagement advertising activities may be worth certain point values, as specified in the specification data for the brand engagement advertising campaign. The cumulative tally of points earned by the group can then translate into a dollar value, for example, which can be used toward the group incentive or incentives, as specified in the specification data for the brand engagement advertising campaign. For example, 100 points could translate to $1.00 to be used towards a designated group incentive of funds towards custom apparel, such as t-shirts. For further example, a group and supporters could earn 10,000 points, which could then translate to $100 to be used towards custom apparel, such as t-shirts. The specification data for the brand engagement advertising campaign may include a maximum amount for the group incentive, such as $100. In such case, once the cumulative tally of points for the group and supporters reaches 10,000 points, for example, the maximum for the group incentive is reached. If on the other hand, the cumulative tally of points for the group and supporters reaches only 8,250 points, the group can still receive $82.50 towards the group incentive, such as funds towards custom apparel, such as t-shirts. Alternatively, the specification data for the brand engagement advertising campaign can indicate that a designated group incentive will be provided by the sponsor once a designated number of points have been earned by the group and the supporters by participating in the designated brand engagement advertising activities. In such case, group incentives would be “unlocked” as the group reaches a certain threshold of points, as designated in the specification data for the brand engagement advertising campaign.

As discussed in further detail below, the brand engagement advertising campaign may also include additional individual and group incentives. For example, the brand engagement advertising campaign may include an individual incentive for performing a brand engagement advertising activity or completing a set of brand engagement advertising activities. For example, an individual user 22 can receive a product sample or an entitlement to a particular service, or a gift card, such as an Amazon.com® or Visa® gift card, or an offer to purchase a sponsor's product or service at a discount for completing a particular brand engagement advertising activity or completing a set of brand engagement advertising activities. Additionally, once a group incentive has been awarded by a sponsor and redeemed by a group, the brand engagement advertising campaign may specify an additional follow-up incentive. For example, if the initial group incentive included sponsor branded custom apparel, such as t-shirts or uniforms, a follow-up incentive may be provided by the sponsor when the group performs an additional follow-up activity related to the initial group incentive and the sponsor. For example, the follow-up incentive can be awarded if the group takes a picture of the entire group wearing the sponsor branded custom apparel from the initial group incentive and posting the picture via a social media outlet, such as Facebook®, Twitter®, or Google+®. Once completing the follow-up activity, the group can then redeem the specified follow-up incentive, which may be additional custom apparel, products, services, food, catering, funds towards charity donations or fundraisers, etc.

The specification data for a particular brand engagement advertising campaign can be customized with target audience data so that the campaign is tailored to specific target groups or types of target groups. For example, a sports drink manufacturer may designate that only certain sports related user groups in certain age groups and locations can qualify to participate in a designated brand engagement advertising campaign sponsored by the sports drink manufacturer. In this way, a sponsor can coordinate the types of users and types of groups that it desires to target for participation in the designated brand engagement advertising activities related to the particular sponsor company. The server 12 can then coordinate and match specific brand engagement advertising campaigns with specific groups of users.

A particular user can interact with the collaborative marketing system 10 as a group leader and can create a group profile for the group that includes data related to the specific type of group and the specific types of users in the group. For example, a group leader can create a group profile for a softball team and indicate in the profile that the team is between the ages of 22 and 35 and consists of an approximately even split of males and females. Based on the group profile data, the server 12 can then find particular brand engagement advertising campaigns with target audience data specifications that match the demographics of the particular group. For example, the server 12 may determine that a brand engagement advertising campaign associated with the sports drink manufacturer sponsor includes target audience data that matches the demographic data for the softball team group. The softball team group can then initiate the brand engagement advertising campaign, rally their supporters to participate in the brand engagement advertising campaign, and earn points towards the designated group incentive, such as funds towards a sponsor branded t-shirt or uniform. The specific targeting/matching criteria can include, for example, information related to: location, such as zip code, address, city/state; group or user type, such as sports team, church group, etc.; group age range; group gender makeup, such as male-female mix of the group; system usage history, such as prior sponsors, quality and level of engagement with designated previous campaigns, success rate of involvement with designated previous campaigns; other consumer profile information, such as online and offline purchase history, household income, etc.

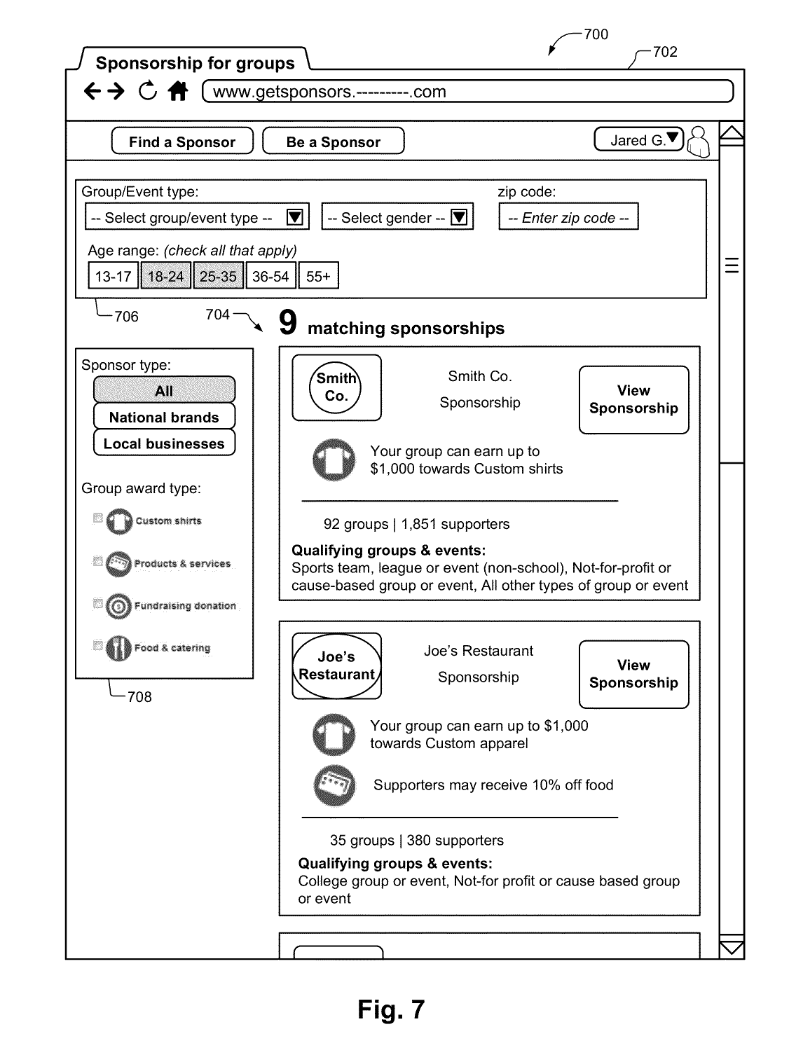

With reference to FIG. 2, the server 12 can include a user interface module 52 that generates the various user interfaces for interaction with the users 20 and the sponsors 30. For example, the users 20 and the sponsors 30 may communicate with the server 12 over a network, such as the internet, via a suitable web browser. The server 12 can generate suitable user interfaces within the web browser, as appropriate. For example, screenshots showing different user interfaces of the collaborative marketing system 10 are shown in FIGS. 7 to 12.

With further reference to FIG. 2, the server 12 can also include a group/brand engagement advertising campaign coordination module 54. The group/brand engagement advertising campaign coordination module 54 can access the target audience data in the specification data for the proposed brand engagement advertising campaigns submitted by the sponsors 30 and the group profile data submitted by a group leader of a group. Based on the group profile data and the target audience data, the group/brand engagement advertising campaign coordination module 54 can provide a listing of brand engagement advertising campaigns that are suitably matched to a particular group.

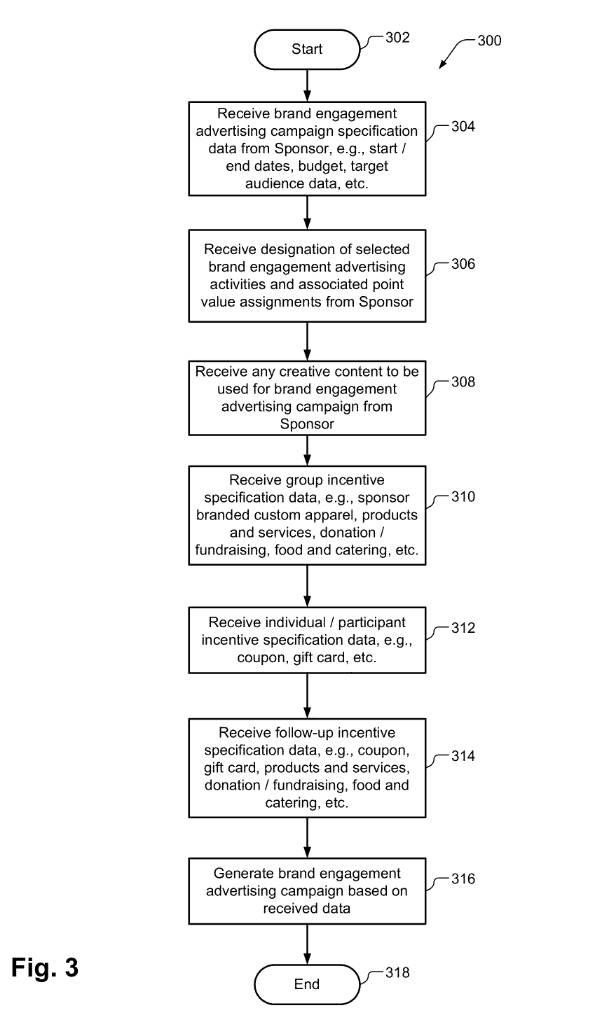

With reference to FIG. 3, a technique 300 for receiving specification data for a brand engagement advertising campaign from a sponsor and for generating a brand engagement advertising campaign is shown. The steps of the technique 300 may generally be performed by the server 12, in conjunction with an individual sponsor 32, for example. The technique starts at 302.

At 304, specification data for a particular proposed brand engagement advertising campaign is received from the sponsor 32. The specification data can include start and end dates and a total budget for the campaign. For example, the sponsor can specify that the campaign should only be active during a selected period of time. In addition, the sponsor can specify a total budget for the campaign, including all costs associated with setting up the campaign, awarding group incentives, individual incentives, follow-up incentives, shipping costs, etc.

In addition, the specification data for the campaign can include target audience data. For example, the target audience data can include certain demographic or user segments. In particular, the server 12 can provide a sponsor 32 with a menu of available user segments or group types. These can include, for example, sports teams, charity organizations, school groups, community groups, and the like. Additionally, the target audience data can include information regarding the gender makeup of the group. For example, the target audience data may indicate a target of all male groups, all female groups, mostly male groups, mostly female groups, approximately even split of gender in the group, etc. Additionally, the target audience data can include information regarding age ranges. For example, the target audience data can specify a target of groups within the age range of 20-35. Additionally, the target audience can include an age threshold. For example, with respect to alcohol related sponsors, the target audience data may specify that only groups with users over the age of 21 can participate in the particular campaign. Additionally, the target audience data can include information regarding geographic areas or zip codes, with an acceptable radius from the center. For example, the target audience data can specify that only groups with users within 10 miles of a designated zip code can participate in the particular campaign. Additionally, the target audience data can include information regarding system usage history, such as prior sponsors, quality and level of engagement with designated previous campaigns, success rate of involvement with designated previous campaigns. Additionally, the target audience data can specify other data or consumer profile attributes, i.e., user groups with particular interests, such as sports, boating, traveling, etc., or particular prior websites visited, or other consumer profile information, such as online and offline purchase history, household income, etc. In this way, a sponsor can narrowly tailor a particular campaign towards a specific type of group through the specified target audience data.

The brand engagement advertising campaign can indicate that the campaign will begin by allotting the group zero points, such that the group members and supporters must perform designated brand engagement advertising activities to increase the group's cumulative point tally. Alternatively, the specification data for the campaign can indicate that the campaign will be initiated with a baseline level of points already awarded such that the group members and supporters will be required to perform certain brand engagement advertising activities for the group to “keep” or maintain those baseline points.

At 306, a designation of selected brand engagement advertising activities, along with associated point value assignments, is received from the sponsor 32. In particular, a menu of available brand engagement advertising activities can be presented and the sponsor 32 can select some or all of the presented activities for inclusion in the brand engagement advertising campaign. For example, the brand engagement advertising activities can include joining the brand engagement advertising campaign as a participating user. The brand engagement advertising activities can also include interacting with the sponsor via a social media outlet, such as Facebook®, Twitter®, Pinterest®, or Google+®. For example, the activity can include “liking” the sponsor on Facebook® or tweeting or re-tweeting a message associated with the sponsor on Twitter®. The brand engagement advertising activities can also include following the sponsor on Twitter® or pinning sponsor related content on Pinterest®. The brand engagement advertising activities can also include watching a video, such as a commercial, associated with the sponsor. The brand engagement advertising activities can also include visiting the sponsor's website. The brand engagement advertising activities can also include participating in a survey regarding the sponsor or sponsor's brand(s). For example, the survey questions can be provided as multiple choice questions or feedback prompts to gauge awareness or opinion of a brand, product, or service. The brand engagement advertising activities can also include opting-in to an email distribution list associated with the sponsor, for distribution of, for example, newsletters, promotions, advertisements, etc. The brand engagement advertising activities can also include creating an account with the sponsor through the sponsor's website, for example. The brand engagement advertising activities can also include making a purchase from the sponsor or a retailer, company or brand designated by the sponsor via an online sales outlet or website. The brand engagement advertising activities can also include any other suitable or appropriate online interaction with a sponsor or brand that can, for example, be monitored and tracked. The examples provided here of the various brand engagement advertising activities are for example only and are not an exhaustive list. For example, any other activities that involve online interaction with a sponsor or related to a sponsor or brand, product, or service, can also be provided as potential brand engagement advertising activities.

Along with the selection of brand engagement advertising activities, at 306 the sponsor's designation of points to be assigned to each particular brand engagement advertising activity in the campaign is also received. For example, the campaign may include a group incentive that can be earned based on the number of points earned by the group and its supporters. For example, as discussed above, 100 points can equal $1.00 earned towards the group incentive, such as custom apparel for the group. The sponsor may designate that interacting with the sponsor via a social media outlet is worth 100 points, for example, while watching a video commercial is worth 150 points.

At 308, any creative content to be used for the brand engagement advertising campaign is received from the sponsor 32. For example, the creative content can include a particular video advertisement to be used as part of a brand engagement advertising activity. The creative content can also include a logo, message, video, or design to be included in any invitations to group members or supporters for participation in the campaign or in any social media interactions with the sponsor.

At 310, the group incentive specification data is received. For example, the group incentive may include sponsor branded custom apparel, products or services, a donation to a charity organization or to a fundraiser, food and catering, etc. The group incentive specification data can indicate the maximum amount of points that can be earned and the translation of points into an actual group incentive. For example, the group incentive specification data can indicate that 100 points equals $1.00 earned towards the group incentive, such as custom apparel for the group, and that a maximum of 100,000 points (or $1,000) can be earned towards that group incentive. For example, the group incentive specification data can indicate that a maximum of $1,000 can be awarded toward custom t-shirts that will include a logo of the sponsor on the sleeve of the custom t-shirt. As such, the group incentive specification data can indicate a maximum group incentive and provide that any point level up to that maximum will convert to a corresponding group incentive. For example, the group incentive specification data can indicate that the maximum point total is 100,000 points, which converts to a group incentive of a $1,000 credit towards custom apparel. Point totals below that maximum, however, can result in corresponding group incentives. For example, a point total of 50,000 can convert to a group incentive of a $500 credit towards custom apparel.

At 312, individual/participant incentive specification data is received. For example, the sponsor 32 can indicate that upon completing certain brand engagement advertising activities, the individual user 22 will be awarded an individual/participant incentive. For example, the individual/participant incentive may include a sample product or an entitlement to a particular service. For further example, the individual/participant incentive can include a gift card, such as an Amazon.com® gift card or a Visa® gift card. The individual/participant incentives can, for example, be awarded once a group member or supporter joins the particular brand engagement advertising campaign or once the group member or supporter joins the campaign and completes one or more designated brand engagement advertising activities.

At 314, follow-up incentive specification data is received. As indicated above, the follow-up incentives may be awarded by the sponsor 32 after the group has earned and received the initial group incentive and has performed an additional activity. For example, if the initial group incentive included sponsor branded custom apparel, such as t-shirts or uniforms, a follow-up incentive can be provided by the sponsor when the group performs an additional follow-up activity related to the initial group incentive and the sponsor. For example, the follow-up incentive can be awarded if the group takes a picture of the entire group wearing the sponsor branded custom apparel from the initial group incentive and posting the picture via a social media outlet, such as Facebook®, Twitter®, or Google+®, with all members of the group tagged in the picture. Once completing the follow-up activity, the group can then redeem the specified follow-up incentive, which can be additional custom apparel, products, services, food, catering, funds towards charity donations or fundraisers, etc. For example, if the group is a softball team, the follow-up incentive can be a rally pack with sponsor branded socks, face paint, hats, etc.

At 316, having received the specification data for the brand engagement advertising campaign from the sponsor 32, the server 12 then generates an appropriate brand engagement advertising campaign record or records for storage in the brand engagement advertising campaign database 46. The technique ends at 318.

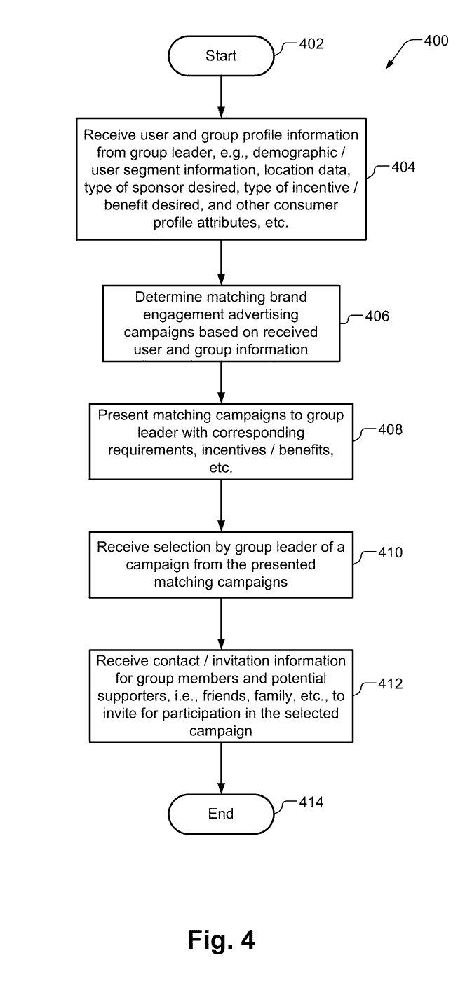

With reference to FIG. 4, a technique 400 for receiving group profile information, determining matching brand engagement advertising campaigns, receiving a selection for a particular campaign, and receiving contact information for group members and potential supporters is shown. The steps of the technique 400 may generally be performed by the server 12, in conjunction with an individual user 22, designated as a group leader, for example. The technique starts at 402.

At 404, user and group profile information is received from a group leader. For example, the group leader can login to the collaborative marketing system 10 and setup a user profile. The user profile for the group leader can include information such as: name, age, gender, location, interests, hobbies, occupation, etc. Once the user profile is created, the group leader can create a group profile. The group profile can indicate the type of group, i.e., sports team, charity organization, school group, community group, etc. The group profile can also indicate specific data about the group such as demographic and user segment information about the group members, the gender makeup of the group, the group age ranges, the group location and/or the locations of the group members, and other data or consumer profile attributes associated with the group or the group members. In addition, the group leader's user profile will be associated with the group. At this point, the group profile will include general information about the group via the group profile, as well as detailed information about the group leader user via the group leader's user profile. As additional members of the group join the collaborative marketing system 10, they will likewise create detailed user profiles that will then be linked to the group profile. In this way, the collaborative marketing system 10 will have detailed information via the associated user profiles for each group member. Further, as discussed below, as supporters join the collaborative marketing system 10, they will likewise create detailed user profiles that can then be linked to the group profile.

At 404, in addition to user profile information received directly from the user, the collaborative marketing system 10 can also receive additional consumer profile attributes from third-party information sources, such as social media outlets and third-party aggregators of consumer information. For example, the collaborative marketing system 10 can utilize social graph information to determine an influencer rating for a particular user. As such, the collaborative marketing system 10 can store the user's influencer rating in the particular user's profile.

At 406, once the user and group profile information is received, the server 12 determines matching brand engagement advertising campaigns based on the received user and group information. Specifically, the server 12 can compare the target audience data from the brand engagement advertising campaign specification data with the received group and user profile data to determine whether the particular group matches with any particular brand engagement advertising campaigns previously submitted by the sponsors 30 and stored in the brand engagement advertising campaign database 46.

At 408, based on the determination performed at 406, a list of matching brand engagement advertising campaigns is presented to the group leader with corresponding data related to the campaign requirement, benefits and incentives, etc.

With additional reference to FIG. 7, a screenshot 700 is shown wherein specific brand engagement advertising campaigns are presented based on data previously input by a group leader. Specifically, in FIG. 7 there are nine campaigns that have been found to match, with two of the nine shown in the screenshot 700. As shown in FIG. 7, the brand engagement advertising campaigns may also be referred to as sponsorships or sponsorship offers. In particular, from the user or group member perspective, the brand engagement advertising campaigns can be thought of and referred to as sponsorships or sponsorship offers. The user-interface shown in FIG. 7 resides within a web-browser window 702. The user-interface includes the listing 704 of the nine matching campaigns. Further, the user-interface includes a group data input frame 706 for selecting the group or event type, the gender makeup of the group, the group's zip code, and the group's age range. For example, in 706, the age ranges for 18-24 and 25-35 and have been checked.

In addition, the user-interface includes a sponsor and benefit selection frame 708. In 708, for example, the sponsor type can be selected as either “All,” “National brands,” or “Local businesses.” In this way, a group leader can select whether brand engagement advertising campaigns for only local or only national brands or businesses should be presented, or whether all campaigns should be presented. Additionally, the group leader can select the benefit types desired for the group incentive so that only applicable brand engagement advertising campaigns are show. For example, the group incentives for potential selection include “Custom shirts,” “Products or services,” “Fundraising donation,” and “Food & catering.” The listing 704 of the nine matching campaigns includes summary information about each particular campaign. For example, the first campaign listed is an offer by the sponsor “Smith Co.” and includes a group incentive of “$1,000 towards Custom shirts.” Further, the qualifying groups for the campaign include the following types: “Sports team, league or event (non-school), Not-for-profit or cause-based group or event, All other types of group or event.” In addition, the summary information shows how many groups have already initiated participation in the campaign (in this case 92 groups) as well as how many supporters have already supported the campaign (in this case 1,851 supporters).

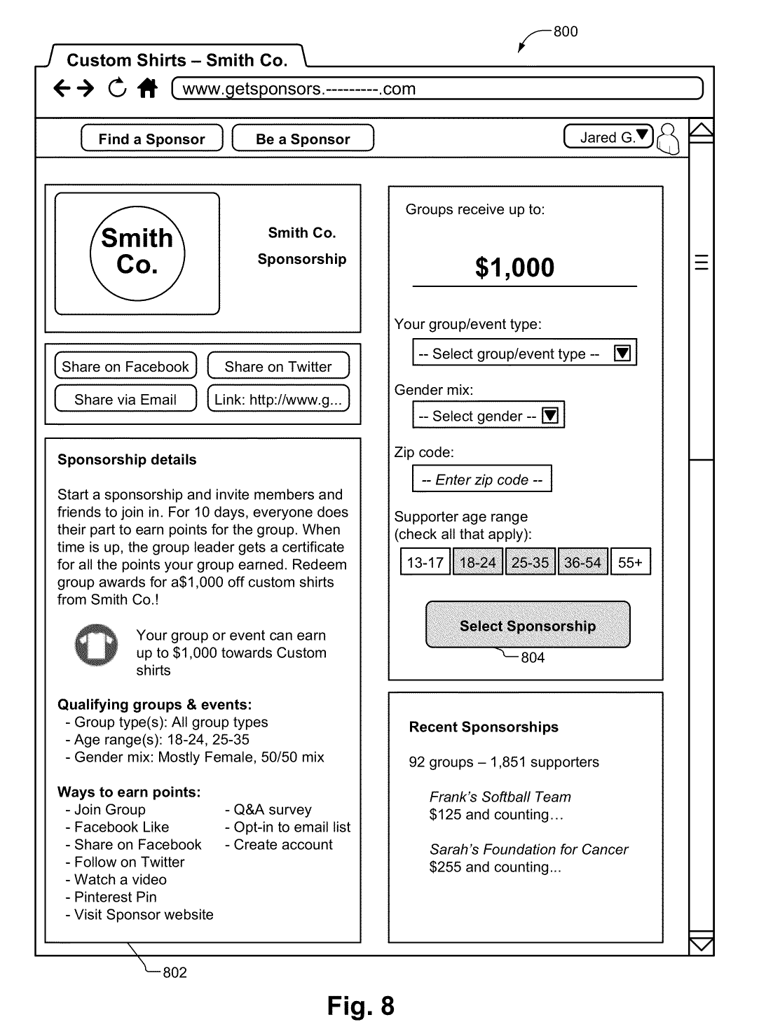

In FIG. 7, the group leader can click on the “View Sponsorship” button for each of the listed campaigns to view additional information about that particular campaign. For example, with additional reference to FIG. 8, a screenshot is shown resulting from the “View Sponsorship” button for the Smith Co. campaign. As shown in FIG. 8, a detailed information frame 802 includes additional details of the campaign. For example, the campaign would last for 10 days. The group incentive is $1,000 towards custom shirts. The qualifying groups are all group types, in the age range of 18-24 and 25-35. The target gender mix for the group is either mostly female or 50/50 male/female mix. Additionally, the detailed information frame 802 lists the various ways to earn points through different brand engagement advertising activities. The user-interface includes buttons to share the campaign with others including though sharing on Facebook®, sharing on Twitter®, and sharing via Email. The user interface also includes a button to retrieve a link to the campaign page. The user-interface also includes additional details as to recent groups participating in the particular campaign. In this case, for example “Franks' Softball Team” and “Sarah's Foundation for Cancer” are participating in the campaign and have earned $125 and $255, respectively, towards the group incentives. The user-interface also includes a “Select Sponsorship” button 804. By pressing the “Select Sponsorship” button 804, a group leader can select this particular campaign for

With reference again to FIG. 4, a selection of a particular campaign from the presented matching campaigns is received at 410. As discussed above, a group leader may select a particular campaign by pressing the “Select Sponsorship” button shown in FIG. 8.

At 412, contact/invitation information for group members and potential supporters is received. For example, the group leader may submit contact information, such as email addresses or mobile phone numbers for texting, for all members of the particular group. In addition, the group leader may submit contact information for potential supporters of the group, e.g., users, such as friends and family, who are not members of the particular group but who may be willing to participate in the various brand engagement advertising activities to support the particular group. The technique ends at 414.

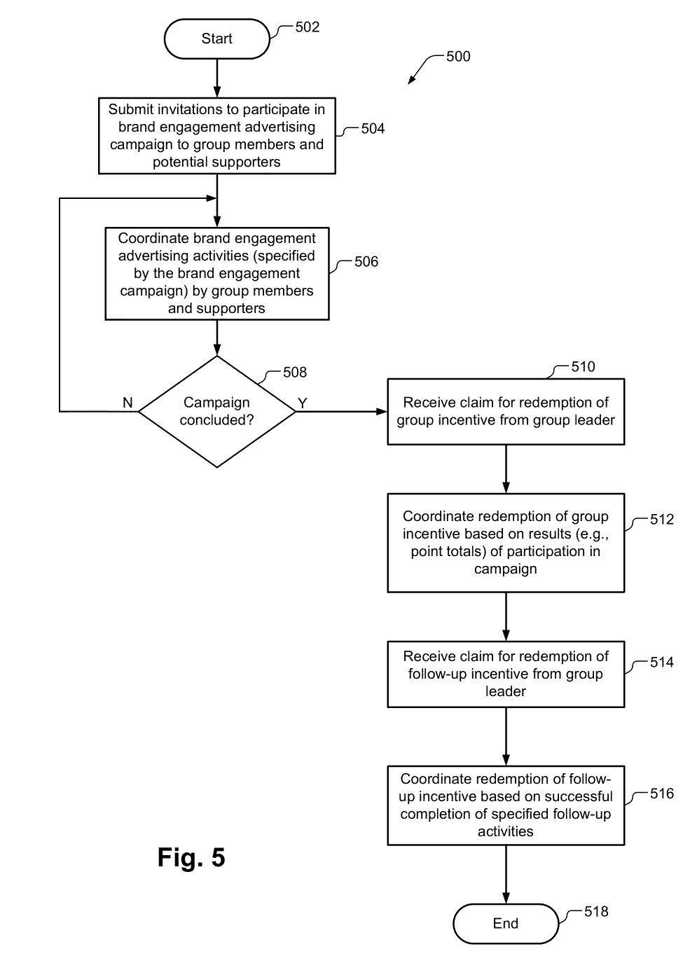

With reference to FIG. 5, a technique 500 for managing a brand engagement advertising campaign is shown. The steps of the technique 500 may generally be performed by the server 12, in conjunction with the user 20, such as a group leader, and the sponsors 30. The technique starts at 502.

At 504, invitations are submitted to group members and potential supporters to participate in the brand engagement advertising campaign. As discussed above in connection with FIG. 4, contact/invitation information for group members and potential supporters is entered by the group leader. For example, the group leader may submit contact information, such as email addresses or mobile phone numbers for texting, for all members of the particular group and for any potential supporters of the group, e.g., users, such as friends and family. At 504, the server 12 sends out invitations via email or text message to the group members and potential supporters. The invitation may include creative content, such as a graphic with a logo or an advertisement video, associated with the supporter.

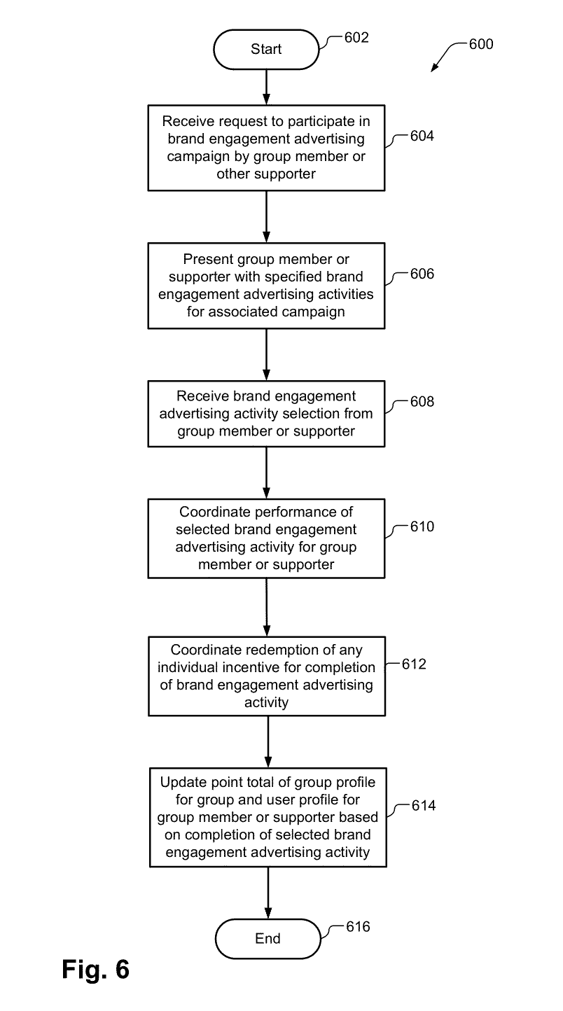

Additionally or alternatively, invitations may be submitted to group members and potential supporters via social media outlets such as Facebook®, Twitter®, Google+®, etc. Additionally or alternatively, invitations may be posted to internet message boards or at other locations on the internet, such as a user or group webpage. Additionally or alternatively, invitations may be communicated by word-of-mouth via in-person meetings or telephone calls, etc. Once a group member or potential supporter has been invited, the group member or potential supporter may use a computing device (24, 25, 26, 27) to communicate with the server 12 and view information about the particular brand engagement advertising campaign and associated brand engagement advertising activities including in the campaign. Additional discussion regarding group member or supporter participation in the brand engagement advertising campaign is included below in connection with FIG. 6.

Additionally, the collaborative marketing system 10 includes a search function whereby individual users can search for particular brand engagement advertising campaigns. For example, an individual user may learn of a particular brand engagement advertising campaign by word-of-mouth and may then later connect to the collaborative marketing system 10 via a suitable computing device. Based on the information learned via the word-of-mouth discussion, the individual user can then search using keywords to local and join the particular brand engagement advertising campaign.

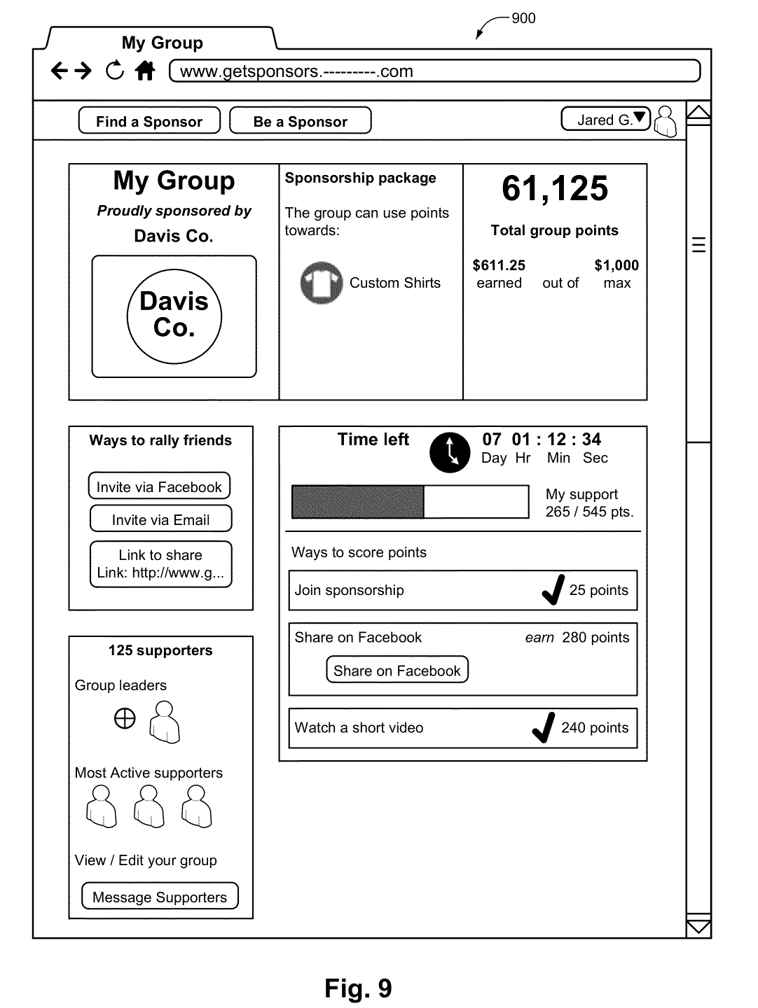

At 506, the performance of brand engagement advertising activities is coordinated, as specified by the brand engagement advertising campaign specification. Specifically, the server 12 monitors group member and supporter activity to track the specific brand engagement advertising activities performed and to continually update the running cumulative point total earned for the group. With additional reference to FIG. 9, for example, a screenshot 900 for a particular group page within the collaborative marketing system 10 is shown. In the case of FIG. 9, the group is “My Group,” which is involved in a brand engagement advertising campaign sponsored by the sponsor “Davis Co.” The page shows that 61,125 total group points have been earned, resulting in a corresponding potential incentive award of $611.25 out of a maximum incentive award of $1,000 being earned. The group incentive in this case is for Custom shirts. The page shows that 7 days, 1 hour, 12 minutes, and 34 seconds remain in this particular brand engagement advertising campaign. Further, the page shows that, thus far, this particular user has completed two out of the three available brand engagement advertising activities. Namely, the user has completed the “Join sponsorship” activity, resulting in 25 earned points and the “Watch a short video” activity, resulting in 240 points. The user has yet to complete the “Share on Facebook” activity, which would earn 280 points. Thus far, the user has earned 265 points of the 545 points available. The page also includes links to invite other users via Facebook®, via email, or by sharing a link. The page also shows that the group currently has 1 group leader and 125 supporters. The page can also be embedded within, and shown at, a webpage associated with the particular group. For example, the group may have a designated homepage and URL associated with its homepage and the group page shown in FIG. 9, for example, can be embedded within the group's designated homepage or a frame, for example, within the group's designated homepage.

With reference again to FIG. 5, at 508 the server 12 determines whether the campaign has concluded. The campaign may be concluded when the specified time has expired. For example, a campaign can be designated to remain open for a specified time period, such as ten days. In addition, the campaign may end early once the maximum number of points has been earned. At 508, when the campaign has not concluded, the server 12 loops back to 506 and continues to coordinate the brand engagement advertising activities by group members and supporters. Additionally or alternatively, an administrator of the collaborative marketing system 10 can end the brand engagement advertising campaign for any reason. For example, the brand engagement advertising campaign may be ended early at the request of the sponsor or due to extenuating circumstances. At 508, when the campaign has concluded, the server proceeds to 510.

At 510, a claim for redemption of a group incentive is received from a group leader. For example, a brand engagement advertising campaign may specify that the group incentive will correspond to the number of points earned, up to a maximum amount. In this way, if the group earns 61,125 points which, under the terms of the campaign, convert to $611.25 towards custom apparel, then the group incentive will correspond to $611.25 credit towards custom apparel. Additionally or alternatively, if the group has earned sufficient points to meet the designated point threshold for the group incentive, the group incentive may be awarded.

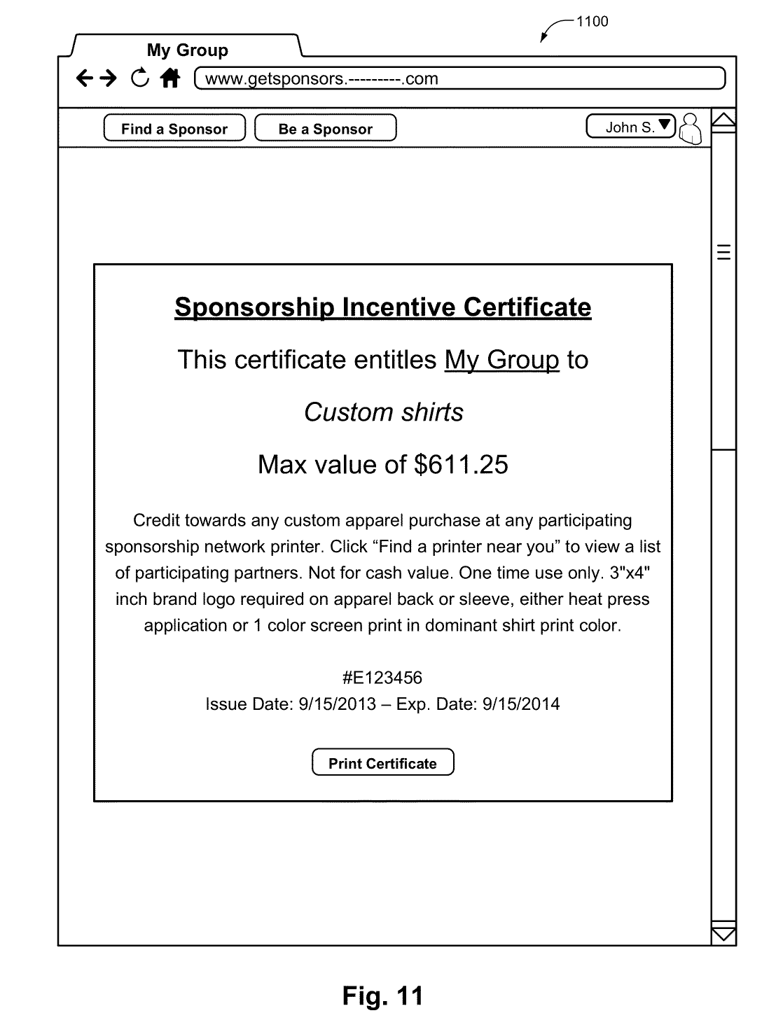

At 512, the redemption of the group incentive is coordinated based on the results, or point totals, of the group member's and supporter's participation in the campaign. For example, the server 12 may issue an award certificate indicating the incentive. With additional reference to FIG. 11, a screenshot 1100 of a “Sponsorship Incentive Certificate” is shown. As depicted in FIG. 11, the group “My Group” has earned $611.25 credit towards any custom apparel purchase at any participating network printer. As indicated in the certificate, a brand logo must appear on the custom shirts on the back or sleeve. Further, the certificate indicates certain requirements of the logo, which must be either heat pressed or color screen printed in a dominant shirt print color. The certificate includes expiration date information. Further, the group leader can use the “Print Certificate” button to print the certificate to take to a participating network printer. Once the certificate is issued, redemption can be coordinated by an administrator of the collaborative marketing system 10 or a predetermined entity or individual designated by an administrator of the collaborative marketing system 10. For example, an administrator of the collaborative marketing system 10 or a predetermined entity or individual designated by an administrator of the collaborative marketing system 10 may coordinate the redemption of funds earned towards custom apparel by interfacing with the participating network printer, ensuring that the sponsor's logo will correctly appear on the custom apparel, interfacing with the group to ensure that the names and colors will appear correctly on the custom apparel, etc. Alternatively, redemption can be facilitated by direct interaction between the group, the group leader, or a designated group member, and the sponsor 32 or a predetermined entity or individual designated by the sponsor 32, without involvement of an administrator of the collaborative marketing system 10. For example, the group incentive may include a coupon to be used towards good and services at a retailer or service provider associated with the sponsor or designated by the sponsor. For example, the group incentive may be funds towards food or catering at a restaurant. In such case, the group may interface directly with the particular retailer or service provider to redeem the group incentive, without further involvement of an administrator of the collaborative marketing system 10. Further, the server 12 may provide a search function whereby the group leader or designated group member can search for a participating network printer or other entity that can redeem the group incentive. In such case, the server 12 may provide a listing of participating network printers, for example, that meet the user's search criteria. The user can then select a participating network printer from the search results and an administrator of the collaborative marketing system 10 or a predetermined entity or individual designated by an administrator of the collaborative marketing system 10 may then coordinate redemption of the group incentive with the selected network printer, or the user may be able to interact directly with the network printer to redeem the group incentive.

In this way, the collaborative marketing system 10 provides to sponsors/advertisers the benefits of performance based billing. Traditionally advertisers must pay for traditional advertising, such as print and broadcast media, ahead of time, before the advertising takes place. With the collaborative marketing system 10, the advertiser may not need to pay any funds for a brand engagement advertising campaign until the redemption of a group incentive, which would occur after the brand engagement advertising activities by the various group members and supporters have already taken place. Additionally, because the sponsors/advertisers know ahead of time the point values for the various brand engagement advertising activities as well as the maximum group and individual incentives, the sponsor/advertiser may be able to estimate ahead of time an estimate of the price it will ultimately pay on a per engagement basis. This type of data and this level of granularity in terms of a per engagement price for advertising is generally not available for traditional advertising.

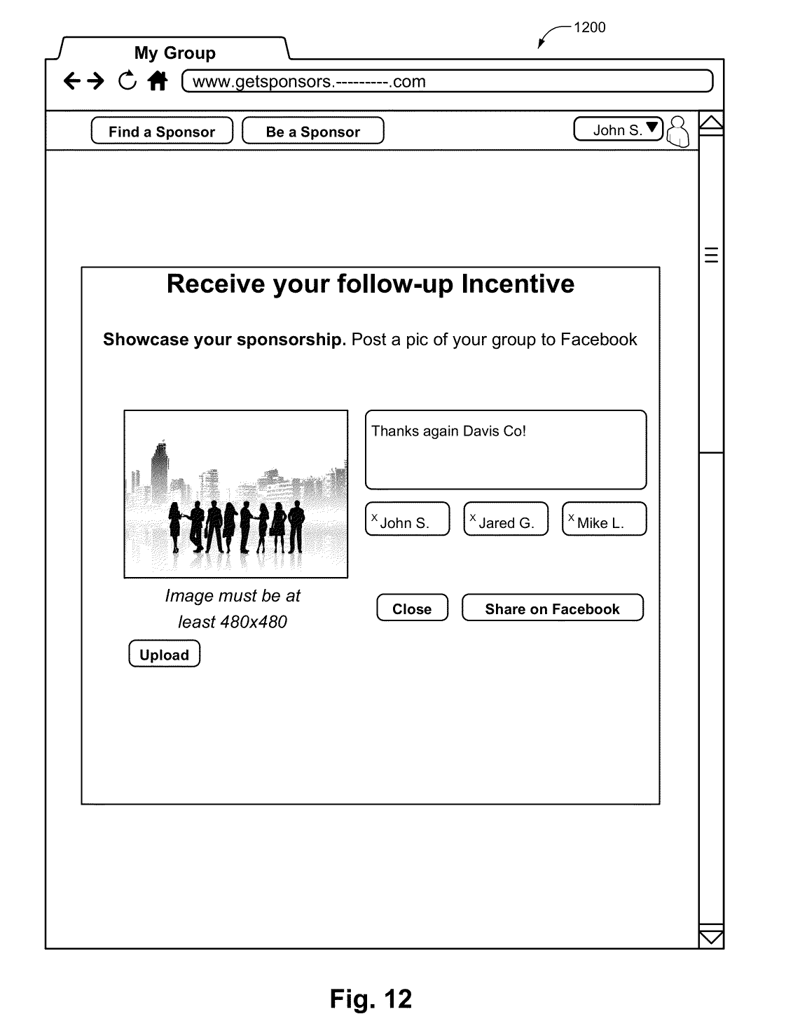

With reference again to FIG. 5, at 514, a claim for redemption of a follow-up incentive is received from a group leader. As discussed above, a brand engagement advertising campaign can have a specified follow-up incentive to be received upon completion of an additional activity. For example, the follow-up incentive activity may include taking a picture of the group wearing the custom apparel that was awarded as the initial group incentive and uploading the picture to a social media outlet, such as Facebook®. With additional reference to FIG. 12, a screenshot 1200 is shown for proceeding with redemption of a follow-up incentive. As shown, the follow-up incentive activity includes uploading a group picture to Facebook® with individual group members tagged in the picture. The picture can be uploaded by pressing the “Upload” button and shared to Facebook® by pressing the “Share on Facebook” button. A message can be entered as well.

With reference again to FIG. 5, at 516, the redemption of the follow-up incentive based on the successful completion of the specified follow-up activity is coordinated. For example, once the successful completion of the follow-up activity is verified, the follow-up incentive can be sent to the group leader. The verification of the follow-up activity can be performed by the server 12, if appropriate, or by a human user, such as an administrator of the collaborative marketing system 10. As an example, the follow-up incentive may be additional custom apparel, products, services, food, catering, funds towards charity donations or fundraisers, etc. In one example, if the group is a softball team, the follow-up incentive may be a rally pack with sponsor branded socks, face paint, hats, etc. The technique ends at 518.

With reference to FIG. 6, a technique 600 for coordinating performance of a particular brand engagement advertising activity by a group member or supporter is shown. The steps of the technique 500 may generally be performed by the server 12, in conjunction with a user 22, such as a group member or supporter. The technique starts at 602.

At 604, a request to participate in a brand engagement advertising campaign is received from a group member or supporter. If the particular group member or supporter has not logged into the collaborative marketing system 10 before, the user can be prompted to create an account and submit information for the user's profile. Once the user has received system credentials and created a user profile, the technique proceeds to 606.

At 606, the group member or supporter is presented with the specified brand engagement advertising activities for the associated brand engagement advertising campaign. The various types of brand engagement advertising activities are discussed above.

At 608, a selection of a particular brand engagement advertising activity is received from the group member or supporter. At 610, the performance of the selected brand engagement advertising activity is coordinated for the group member or supporter. For example, this may include providing a video for the group member or supporter to view, providing a link for the group member or supporter to share content on a social media outlet, etc. Once the brand engagement advertising activity is completed, the technique proceeds to 612.

At 612, the redemption of any individual incentive for completion of the brand engagement advertising activity is coordinated. Individual incentives are discussed in detail above and may include, for example, a sample or an entitlement to a particular service, or a gift card, such as an Amazon.com® or Visa® gift card. Further, as discussed above with respect to the group incentives, redemption of an individual incentive can likewise be coordinated either with or without the involvement of an administrator of the collaborative marketing system 10 or a predetermined entity or individual designated by an administrator of the collaborative marketing system 10. For example, an administrator of the collaborative marketing system 10 or a predetermined entity or individual designated by an administrator of the collaborative marketing system 10 may coordinate the redemption of the individual incentives by interfacing with the particular individual and the particular entity providing the individual incentive. Alternatively, redemption can be facilitated by direct interaction between the individual and the sponsor 32 or predetermined entity or individual designated by the sponsor 32, without involvement of an administrator of the collaborative marketing system 10. For example, the individual incentive may include a coupon to be used towards good and services at a retailer or service provider associated with the sponsor or designated by the sponsor. For example, the individual incentive may be funds to be used towards food at a restaurant. In such case, the individual may interface directly with the particular retailer or service provider to redeem the individual incentive, without further involvement of an administrator of the collaborative marketing system 10.

At 614, the point total for the group associated with the particular brand engagement advertising campaign is updated to reflect the successful completion of the particular brand engagement advertising activity by the group member or supporter. For example, with reference to FIG. 9, the total group points for the group “My Group” is shown as 61,125 points. With reference again to FIG. 6, at 616 the technique ends.

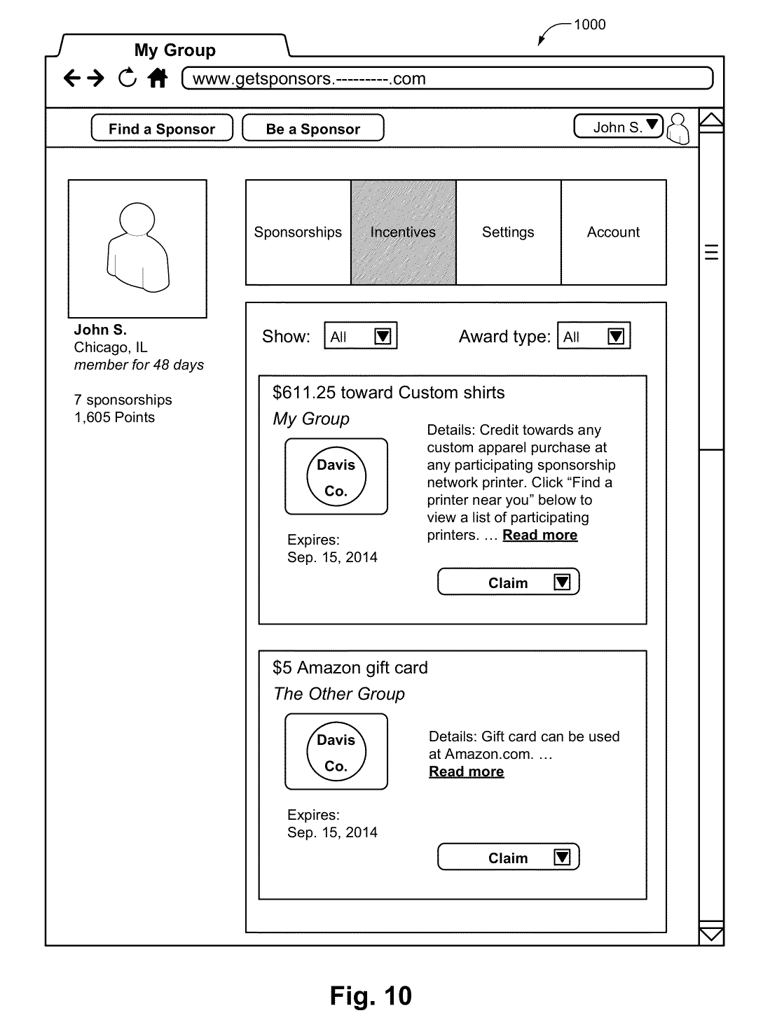

With reference to FIG. 10, a screenshot 1000 is shown for a user page associated with a group member or supporter. The user page includes buttons for “Sponsorships,” “Incentives,” “Settings,” and “Account.” When the “Sponsorship” button is pressed, the various brand engagement advertising campaigns associated with the particular user are shown. For example, all of the brand engagement advertising campaigns that the particular user has participated in can be shown. When the “Incentives” button is pressed, a listing of all incentives, including group incentives, individual incentives, and follow-up incentives that the particular user has received or contributed towards are shown. For example, in FIG. 10 the “Incentives” button has been pressed and two earned incentives are shown—one for being associated with a group incentive of $611.25 towards Custom shirts for the group “My Group” and the other being an individual incentive of a $5 Amazon.com® gift card for performing a brand engagement advertising activity in a brand engagement advertising campaign for a group “The Other Group.” When the “Settings” button is pressed, associated user settings are displayed for editing. When the “Account” button is pressed, associated account settings are displayed for editing.

Additionally, individual user achievement badges can be unlocked or awarded by the collaborative marketing system 10 based on the individual user's participation in multiple brand engagement advertising campaigns or groups of brand engagement advertising activities. For example, if a user participates in a predetermined threshold number of brand engagement advertising campaigns associated with a particular sponsor, the individual user can be awarded a badge indicating the individual user's achievement. The badge can then appear on the individual user's page. Additionally, the badge can then entitle the individual user to an additional incentive. For example, if the particular sponsor may award and incentive to the individual user based on the individual user's performance. As an example, if the sponsor is a bank, the individual user may receive an offer for a special checking account. Additionally, the badge can be earned by participating in particular types of groups. For example, if the individual user participates in or supports a predetermined threshold of charity or not-for-profit groups, the user may be awarded a badge indicating the individual user's participation in those types of groups. One or more sponsors can then award individual incentives to individual users that have attained that particular badge.

As described above, through operation and coordination of the various brand engagement advertising campaigns, the collaborative marketing system 10 can collect detailed user and group profile data, including information related to specific user and group interests. This user and group profile data can be further augmented by data procured from third party providers that map group and individual associations, connections, relationships, online and real world influence, associated real world interests, and causes, demographic and geographic information, and the like. This detailed user/consumer and group profile data can then be leveraged to optimize the delivery of future marketing and sponsorship campaigns and offers within and outside of the collaborative marketing system 10.

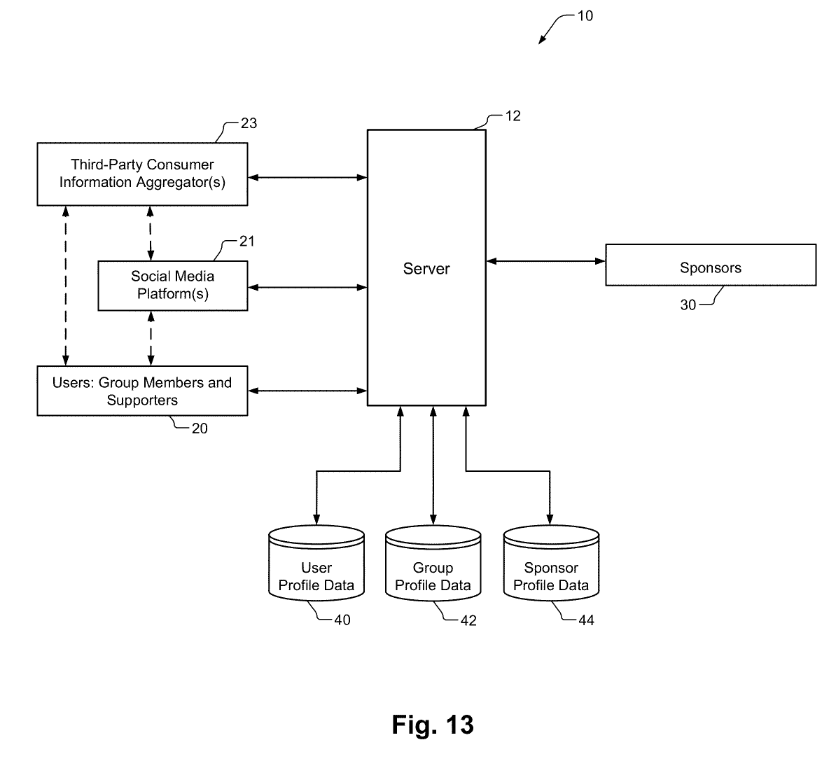

With reference to FIG. 13, the collaborative marketing system 10 can include communication links with various social media platforms 21 and third-party consumer information data aggregators 23. For example, as shown in FIG. 13, server 12 can communicate with social media platforms 21, such as Facebook®, Twitter®, Pinterest®, or Google+®. The users 20 utilize the social media platforms 21 and may post information related to their interests, hobbies, etc. on the various social media platforms 21, as shown by the dotted line between the users 20 and the social media platforms 21. Server 12 can then communicate with the various social media platforms 21 and pull data related to the users 20 of the collaborative marketing system 10. For example, server 12 may interface with Facebook® via Facebook's Open Graph API. For example, server 12 can pull data related to user profiles contained on the social media platforms 21, the friends and connections linked to the user on the social media platform 21, posts that have been “liked,” “re-tweeted,” and/or “reposted” on the social media platforms 21, and any other social media activity tracked, managed, or posted by the social media platforms 21 associated with users 20 of the collaborative marketing system 10. Additionally, server 12 can pull data related to purchases, purchasing activity, website views, advertising views, etc., and other activity tracked, managed, or posted by the social media platforms 21. Data obtained by the server 12 from the social media platforms 21 can then be integrated with the data associated with the particular user in the user profile database 40. In this way, the user profile database 40 may store detailed information about the particular user, based on data obtained from the user's activities within the collaborative marketing system 10, as well as data obtained from the user's activities within the various social media platforms 21, including the user's purchasing behavior and activities.

Additionally, server 12 can communicate with various third-party consumer information data aggregators 23 to obtain additional data related to the consumer behavior, interests, purchasing history and habits, marketing and advertising interests, etc., for the users of the collaborative marketing system 10. As shown by the dotted lines, the third-party consumer information data aggregators 23 can obtain consumer related information directly from the users 20 or from the social media platforms 21. The consumer information obtained by the server 12 from the third-party consumer information data aggregators 23 can then be integrated with the data associated with the particular user in the user profile database 40.

Based on the data obtained by the server 12 from the social media platforms 21 and third-party consumer information data aggregators 23, the collaborative marketing system 10 can present detailed information about its users to the sponsors 30. In this way, based on the detailed information about the users of the collaborative marketing system 10, the sponsors 30 can create targeted online brand engagement advertising campaigns, narrowly tailored to specific groups of users, thereby providing a greater likelihood of user participation and meaningful brand engagement advertising activities between the sponsor, or sponsor's brands, and the targeted users.

Sponsors 30 can then login to the collaborative marketing system 10 and obtain and review the detailed information about the users 20 of the collaborative marketing system 10 to narrowly tailor online brand engagement advertising campaigns to specific consumer segments, as represented by the detailed user information.

Additionally, once a particular brand engagement advertising campaign is initiated and in progress, or after a particular brand engagement advertising campaign has concluded, sponsors 30 can login to the collaborative marketing system 10 and review and analyze the detailed user information to determine the effectiveness of the particular brand engagement advertising campaign and to determine usage patterns in terms of the types of users that were most likely or least likely, to participate in the particular brand engagement advertising campaign. In this way, sponsors 30 may be able to utilize the detailed user information to gain understanding of the users' perception of their brand and likelihood of engaging with the particular brand. Further, the sponsors 30 may be able to review and analyze data with respect to completed brand engagement advertising activities, analytics and metrics of the users that completed various brand engagement advertising activities, etc.

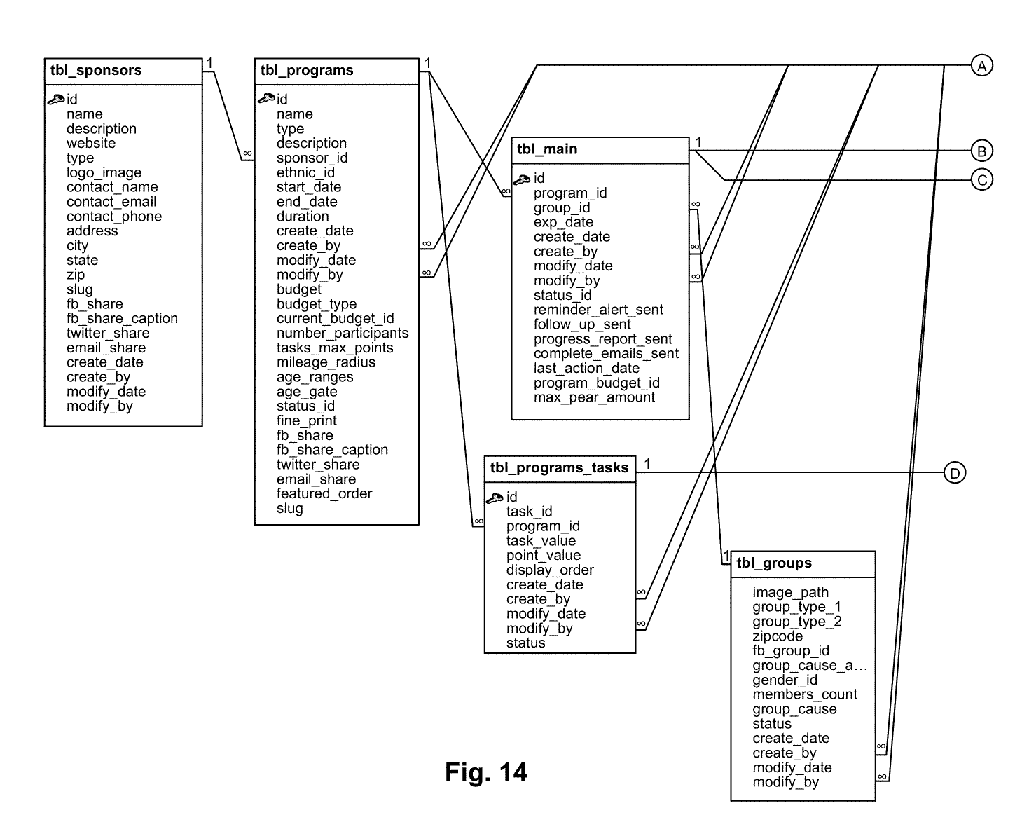

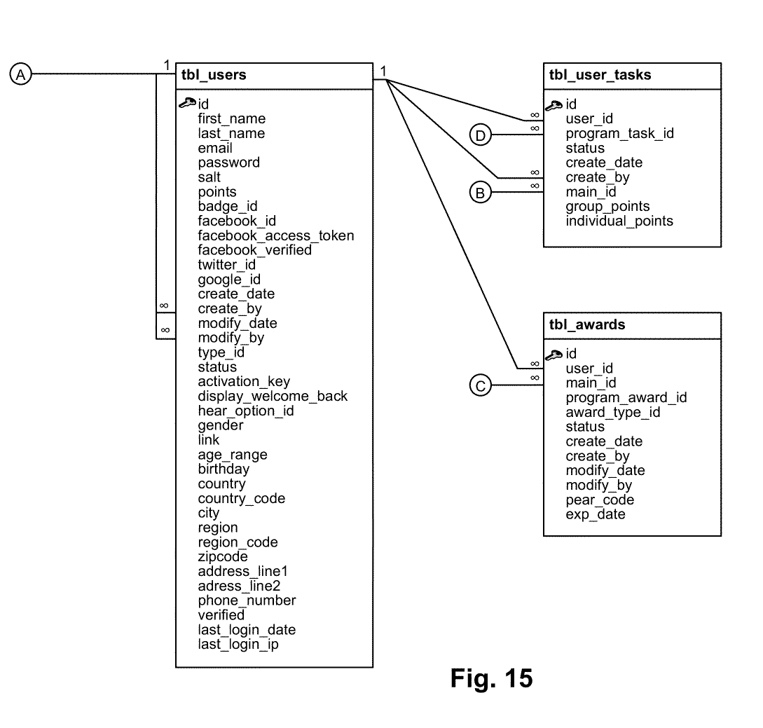

With reference to FIGS. 14 and 15, particular database tables and fields used by the collaborative marketing system 10, and the various databases 40, 42, 44, and 46, are shown. In particular, the database tables include a “tbl_programs” table that is linked to a “tbl_sponsors” table, a “tbl_main” table, a “tbl_programs_tasks” table, and a “tbl_users” table. The “tbl_main” table is also linked to the “tbl_users” table, “tbl_user_tasks” table, a “tbl_awards” table, and a “tbl_groups” table. The “tbl_programs_tasks” table is also linked to the “tbl_users” table and the “tbl_user_tasks” table. The “tbl_groups” table is also linked to the “tbl_users” table. The “tbl_users” table is also linked to the “tbl_user_tasks” table and the “tbl_awards” table.

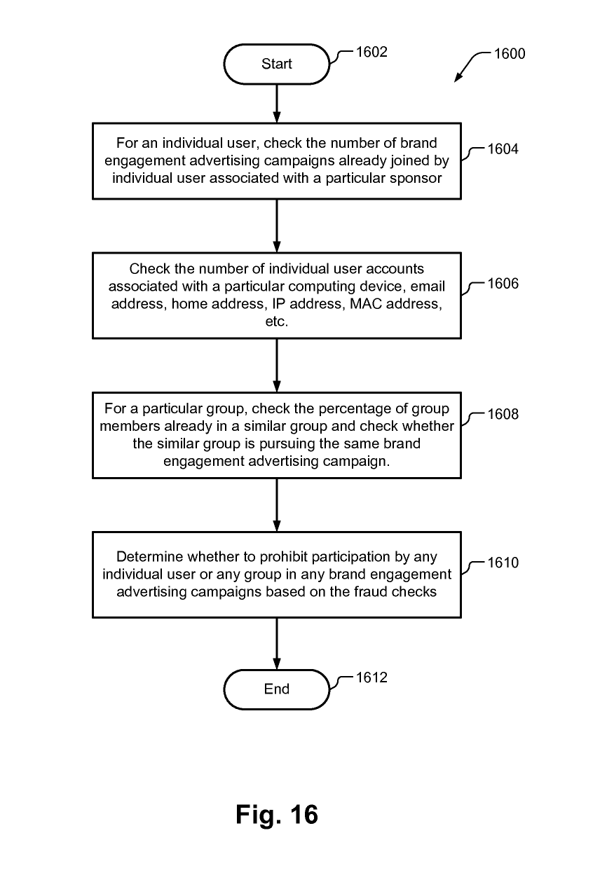

With reference to FIG. 16, a technique 1600 for performing fraud checking based on individual user and user group information is shown. The steps of the technique 1600 may generally be performed by the server 12. The technique starts at 1602.

At 1604, for each individual user registered with the collaborative marketing system 10, when the user submits a request to join or participate in a new brand engagement advertising campaign, the user's history is reviewed and analyzed to determine whether the user has already joined this particular brand engagement campaign, or a similar brand engagement campaign, with the particular sponsor. The server 12 can track the number of previous brand engagement advertising campaigns already joined by the individual user and can prevent the individual user from participating in more than a predetermined number of brand engagement advertising campaigns associated with a particular sponsor. As an example, if a particular sponsor offers a brand engagement advertising campaign with a group incentive of funds for customized apparel, the server 12 can prevent a user from participating in that particular brand engagement advertising campaign more than a predetermined threshold number of times.

At 1606, the number of individual user accounts associated with identification information is reviewed and analyzed to determine whether multiple individual user accounts are being generated from the same source. For example, the server 12 can check whether multiple individual user accounts are being generated from the same computing device, i.e., desktop computer, laptop computer, tablet device, or smartphone, etc. The server 12 can check whether multiple individual user accounts are being generated using the same email address or physical street/home address. The server 12 can also check whether multiple individual user accounts are being generated from the same IP address. The server 12 can also check whether multiple individual user accounts are being generated from the same MAC address.

At 1608, for a particular group, the individual users that comprise the particular group are reviewed and any overlap with existing groups is determined. Further, if the membership of a particular group has significant overlap with an existing group, the brand engagement advertising campaigns associated with each group are reviewed to determine whether the two groups, with significant overlapping membership, are attempting to pursue the same brand engagement advertising campaign. In such case, a duplicate group condition may exist and the server 12 can prevent the second group, with the significant membership overlap, from pursuing the same brand engagement advertising campaign as the previous group. For example, a first group may include 50 individual members, and may be pursuing a particular brand engagement advertising campaign. The server 12 can recognize if a second group is then created and has significant membership overlap with the first group. For example, the server 12 can recognize if the second group has membership overall with the first group that is greater than a predetermined percentage threshold. For example, the server 12 may recognize that 40 out of 50 members in the second group are already in the first group. If the second group then attempts to join a brand engagement advertising campaign that has already been joined by the first group, the server 12 may recognize this as a duplicate group condition whereby similar groups are attempting to pursue the same brand engagement advertising campaigns. In such case, the server 12 may flag the condition and prevent the second group from pursuing the same brand engagement advertising campaign.

At 1610, based on the fraud checking performed at steps 1604, 1606, and 1608, the server 12 determines whether to prohibit participation by any individual user or any group in any brand engagement advertising campaigns. The technique ends at 1612.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Further, example embodiments are provided so that this disclosure will be thorough, and will fully convey the scope to those who are skilled in the art. Numerous specific details are set forth such as examples of specific components, devices, techniques, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

As used herein, the term module may refer to, be part of, or include: an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses, techniques, and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A method comprising:
receiving, at a server, specification data for a plurality of brand engagement advertising campaigns from at least one sponsor, the specification data for each brand engagement advertising campaign including data indicating at least one brand engagement advertising activity and a group incentive for the associated brand engagement advertising campaign;
storing, at the server, the specification data for the plurality of brand engagement advertising campaigns;
providing, at the server, access to the specification data for the plurality of brand engagement advertising campaigns to a plurality of users;
receiving, at the server and from a first user of the plurality of users, a selection of a designated brand engagement advertising campaign from the plurality of brand engagement advertising campaigns, the designated brand engagement advertising campaign having an associated sponsor;
monitoring, with the server, performance of the at least one brand engagement advertising activity associated with the designated brand engagement advertising campaign by the first user and at least one second user from the plurality of users;
notifying, with the server, the first user that the group incentive associated with the designated brand engagement advertising campaign has been awarded by the associated sponsor for the designated brand engagement advertising campaign, based on the monitored performance of the at least one designated brand engagement advertising activity associated with the designated brand engagement advertising campaign.

2. The method of claim 1, further comprising:
receiving, at the server and from the first user, contact information for the at least one second user of the plurality of users;
sending, with the server, an invitation to participate in the designated brand engagement advertising campaign to the at least one second user based on the received contact information.

3. The method of claim 1, wherein the specification data for each brand engagement advertising campaign of the plurality of brand engagement advertising campaigns includes target audience data, the method further comprising:
receiving, at the server and from the first user, group profile data for a group of users, the group profile data including demographic information and location information for the group of users;
comparing, with the server, the group profile data for the group of users with the target audience data for each brand engagement advertising campaign of the plurality of brand engagement advertising campaigns;
determining, with the server, at least one matching brand engagement advertising campaign from the plurality of brand engagement advertising campaigns based on the comparing;
providing, with the server, the at least one matching brand engagement advertising campaign to the first user;
wherein the selection of the designated brand engagement advertising campaign is made by the first user from the provided at least one matching brand engagement advertising campaign.

4. The method of claim 3, wherein the received group profile data includes at least one of: an age range for the group; gender data for the group; consumer profile attributes for the group; and desired sponsor data indicating a type of sponsor desired for the group.

5. The method of claim 1, wherein the at least one designated brand engagement advertising activity includes at least one of: joining the associated brand engagement advertising campaign; interacting via at least one social media outlet with the associated sponsor for the associated brand engagement advertising campaign; watching a designated video for the associated brand engagement advertising campaign; participating in a survey for the associated brand engagement advertising campaign; opting in to a designated email distribution list; and creating an account with the associated sponsor for the associated brand engagement advertising campaign.

6. The method of claim 5, wherein the at least one designated brand engagement advertising activity includes interacting via the at least one social media outlet with the associated sponsor for the associated brand engagement advertising campaign and wherein the at least one social media outlet includes at least one of Facebook®, Twitter®, Pinterest®, and Google+®.

7. The method of claim 1, wherein the group incentive for the designated brand engagement advertising campaign includes at least one of: funds to be used for sponsor branded custom apparel; funds to be used for products; funds to be used for services; funds to be used for food or catering; and funds to be used as a donation to a charity group.

8. The method of claim 1, wherein the specification data for the designated brand engagement advertising campaign includes at least one individual incentive to be awarded to any user that performs the at least one brand engagement advertising activity associated with the designated brand engagement advertising campaign.

9. The method of claim 8, wherein the at least one individual incentive includes at least one of a sample product and a gift card.

10. The method of claim 1, wherein the specification data for the designated brand engagement advertising campaign includes at least one follow-up incentive to awarded to a group after receiving the group incentive and after performing an a designated additional brand engagement advertising activity associated with the designated brand engagement advertising campaign.

11. The method of claim 1, further comprising:
receiving, at the server and from the at least one second user, contact information for at least one third user of the plurality of users;
sending, with the server, an invitation to participate in the designated brand engagement advertising campaign to the at least one third user based on the received contact information from the at least one second user.

12. The method of claim 1, further comprising:
storing, at the server, consumer data for each user of the plurality of users that participates in the at least one designated brand engagement advertising activity for the designated brand engagement advertising campaign;
retrieving, at the server, additional consumer data from a third-party source of consumer data for at least one user of the plurality of users that participates in the at least one designated brand engagement advertising activity for the designated brand engagement advertising campaign;
storing, at the server, the additional consumer data;
submitting, with the server, advertisements or marketing material to the at least one user of the plurality of users based on the additional consumer data.

13. A server with a computer readable storage medium storing instructions executable by a processor for:
receiving specification data for a plurality of brand engagement advertising campaigns from at least one sponsor, the specification data for each brand engagement advertising campaign including data indicating at least one brand engagement advertising activity and a group incentive for the associated brand engagement advertising campaign;
storing the specification data for the plurality of brand engagement advertising campaigns;
providing access to the specification data for the plurality of brand engagement advertising campaigns to a plurality of users;
receiving, from a first user, of the plurality of users a selection of a designated brand engagement advertising campaign from the plurality of brand engagement advertising campaigns, the designated brand engagement advertising campaign having an associated sponsor;
monitoring performance of the at least one brand engagement advertising activity associated with the designated brand engagement advertising campaign by the first user and at least one second user from the plurality of users;
notifying the first user that the group incentive associated with the designated brand engagement advertising campaign has been awarded by the associated sponsor for the designated brand engagement advertising campaign, based on the monitored performance of the at least one designated brand engagement advertising activity associated with the designated brand engagement advertising campaign.

14. The server of claim 13, further comprising:
receiving, from the first user, contact information for the at least one second user of the plurality of users;
sending an invitation to participate in the designated brand engagement advertising campaign to the at least one second user based on the received contact information.

15. The server of claim 13, wherein the specification data for each brand engagement advertising campaign of the plurality of brand engagement advertising campaigns includes target audience data, the computer readable storage medium storing further instructions executable by the processor for:
receiving, from the first user, group profile data for a group of users, the group profile data including demographic information and location information for the group of users;
comparing the group profile data for the group of users with the target audience data for each brand engagement advertising campaign of the plurality of brand engagement advertising campaigns;
determining at least one matching brand engagement advertising campaign from the plurality of brand engagement advertising campaigns based on the comparing;
providing the at least one matching brand engagement advertising campaign to the first user;
wherein the selection of the designated brand engagement advertising campaign is made by the first user from the provided at least one matching brand engagement advertising campaign.

16. The server of claim 15, wherein the received group profile data includes at least one of: an age range for the group; gender data for the group; consumer profile attributes for the group; and desired sponsor data indicating a type of sponsor desired for the group.

17. The server of claim 13, wherein the at least one designated brand engagement advertising activity includes at least one of: joining the associated brand engagement advertising campaign; interacting via at least one social media outlet with the associated sponsor for the associated brand engagement advertising campaign; watching a designated video for the associated brand engagement advertising campaign; participating in a survey for the associated brand engagement advertising campaign; opting in to a designated email distribution list; and creating an account with the associated sponsor for the associated brand engagement advertising campaign.

18. The server of claim 17, wherein the at least one designated brand engagement advertising activity includes interacting via the at least one social media outlet with the associated sponsor for the associated brand engagement advertising campaign and wherein the at least one social media outlet includes at least one of Facebook®, Twitter®, Pinterest®, and Google+®.

19. The server of claim 13, wherein the group incentive for the designated brand engagement advertising campaign includes at least one of: funds to be used for sponsor branded custom apparel; funds to be used for products; funds to be used for services; funds to be used for food or catering; and funds to be used as a donation to a charity group.

20. The server of claim 1, wherein the specification data for the designated brand engagement advertising campaign includes at least one individual incentive to be awarded to any user that performs the at least one brand engagement advertising activity associated with the designated brand engagement advertising campaign.

21. The server of claim 20, wherein the at least one individual incentive includes at least one of a sample product and a gift card.

22. The server of claim 13, wherein the specification data for the designated brand engagement advertising campaign includes at least one follow-up incentive to awarded to a group after receiving the group incentive and after performing an a designated additional brand engagement advertising activity associated with the designated brand engagement advertising campaign.

23. The server of claim 13, the computer readable storage medium storing further instructions executable by the processor for:
receiving, from the at least one second user, contact information for at least one third user of the plurality of users;
sending an invitation to participate in the designated brand engagement advertising campaign to the at least one third user based on the received contact information from the at least one second user.

24. The server of claim 13, further comprising:
storing consumer data for each user of the plurality of users that participates in the at least one designated brand engagement advertising activity for the designated brand engagement advertising campaign;
retrieving additional consumer data from a third-party source of consumer data for at least one user of the plurality of users that participates in the at least one designated brand engagement advertising activity for the designated brand engagement advertising campaign;
storing the additional consumer data;
submitting advertisements or marketing material to the at least one user of the plurality of users based on the additional consumer data.
